(19) United States
(12) Patent Application Publication
(10) Pub. No.: US 2022/0406115 A1
(43) Pub. Date: Dec. 22, 2022

(54) EIS METHOD

(71) Applicants: Ornella Lis Mazza, Badger, CA (US); Robert Coleman Hart, Badger, CA (US)

(72) Inventors: Ornella Lis Mazza, Badger, CA (US); Robert Coleman Hart, Badger, CA (US)

(21) Appl. No.: 17/838,688

(22) Filed: Jun. 13, 2022

Related U.S. Application Data
(60) Provisional application No. 63/211,855, filed on Jun. 17, 2021.

(51) Int. Cl. G07C 13/00

(52) U.S. Cl. CPC G07C 13/00

(57) ABSTRACT

This invention relates to a system for voting in national, state or local elections for election of officers or on any pertinent issue. The system is equally applicable to periodic polling of public opinion by any private or public agency on matters of public concern.

The system embodies the complete voting process beginning with the registration and identification of the eligible voter thru the ultimate count of the complete vote as well as an easy audit system. As such, it embodies and envisions new and novel techniques and procedures in which the combination of a number of new and novel devices and mechanisms are utilized.

This Voting system allows voters to securely vote online or at a polling location on paper ballots. This voting system allows every voter to receive an exact copy of the ballot submitted and a way to verify online that the ballot was counted correctly. This method allows the public to audit an election while every voter remains anonymous. This method of voting not only reduces the costs of elections and voter traffic at the polls, but insures an absolute honest election that is as fraud-proof as online banking.

### FIELD OF THE INVENTION

This method is to be used by the public, for secure and fraud-proof voting. This method is unique in that it is a completely verifiable and permits the voter to verify that their ballot was counted correctly with an exact copy receipt to the voter. This system of voting is also auditable by the public causing the public to be confident that the election is honest while keeping the identity of every voter anonymous. This method is designed to be used by society in all elections and maintain automatic chain of custody of all voting transactions.

### BACKGROUND OF THE INVENTION

Our present election systems currently have no way for a voter to verify that their ballot was counted correctly. Chain of custody is lost along the way because no voter can verify their ballot was counted correctly. This in turn, is not only an improper business practice, but further causes mistrust in the voting system, thereby diminishing faith in our democratic republic. Our current elections systems cannot control chain of custody and subject to fraud without detection by many different means and deviates from standard business practices of security and verification. Our current election system processes require a substantial amount of effort, time and money to conduct, manage and audit.

This invention creates a system of voting that makes it impossible to fraud an election, especially by large scale fraud by instituting standard business practices of verification and security, creating a method to easily audit an election by the public.

### SUMMARY OF THE INVENTION

This invention creates a secure and anonymous voting system where people can either vote in person at a polling location or vote securely online from any location. This invention also creates a way for the public to be able to audit any election and verify that any ballot was counted correctly. This election system prevents fraud in a reliable manner.

This invention contains the methods and machines that create a verifiable, fraud-proof voting system with the following methods and machines:
Voter Registration Software that verifies and records voters' identification, electronic signature, biometric fingerprint (or facial recognition or iris scan and any and all variations of this). The Voter registration process creates a Voter Registration Number or barcode or QR code unique to each registered voter. The registration process has the option to verify names, birthdates, birthplaces or naturalization numbers with government data banks and any and all variations of this.
This system incorporates an On-Demand Ballot Printing Machine to be used at the polling stations. This machine verifies the voter's electronic, electronic fingerprint or facial recognition or iris recognition information stored in the voter registration data-bank records. Once the voter's identification is verified, the machine will print an on-demand ballot on watermarked paper ballots or other counterfeit-proof methods and any and all variations of this.
Each ballot is unique to each voter by way of a Voter Registration Number, barcode or QR code printed on the ballot and any and all variations of this.
A Ballot Submission and Tabulation Machine that:
   Has a paper feeder slot where the voter feeds the completed ballot into the machine to be read and any and all variations of this.
   Shows a high-resolution electronic image of the ballot on a monitor screen that shows colored circles or other identifying marks around or on or near every filled in oval marks on the ballot and any and all variations of this.
   Electronically creates and prints a ballot serial number (shuffled in lots of 10 or other number variations) on the submitted (cast) ballot and any and all variations of this.
   Allows the voter to verify on the screen, that the tabulator has read the ballot correctly before submitting (casting) the ballot and any and all variations of this.
   Upon submitting (casting) the ballot, the machine prints the colored verification marks on the ballot to further verify in hard copy that the tabulator machine recorded the ballot results as it was shown on the screen and any and all variations of this.
   Makes an exact copy of the original ballot with the colored marks as a receipt for the voter and any and all variations of this.
   Electronically reads, tabulates and stores all ballot images and ballot tally information and any and all variations of this.
   Organizes all ballot information and ballot numbers into a Ledger Sheet that is listed in alphabetical and numerical order and any and all variations of this.
   Upon ballot submission (cast), the printer inside the submission machine, marks the colored verification circles or other types of marks on or near the filled in oval mark data of original ballot and any and all variations of this.
   Prints a photocopy of the ballot that has been marked with colored circles or marks and assigns and prints a consecutively generated ballot number on water marked paper or other counterfeit-proof methods and any and all variations of this.
   Can upload the ballot images, ledger sheets, poll certification sheets and ballot information summary to a flash drive or equivalent and any and all variations of this. This information must be sent to other locations via said flash drive. This prevents the machine from ever being in contact with the internet or other possible nefarious information.
   Cannot be connected to the internet, does not have a modem or any external method or ports to download programs or information into the machine and any and all variations of this. Any modification of software or hardware in a machine will have to be done by opening the insides of a machine and performed by a service technician. All access points to the insides of the machines are locked. Any time a machine is opened it registers and logs a time, date and personnel access number and any variation of this.
An Election website that lists the information stored on all Ballot Submission Machine's Ledger Sheets, in numerical and alphabetical order, shows images of all ballots, summary of ballot information (election results) and poll certifications and all variations of this.
A method of securely voting online from your computer, tablet, cell phone or other electronic methods very similar to online banking and verification with usernames and passcodes
The online voting method sends a copy of the voter's ballot to the voter's email that the voter gave when they registered to vote.

### DETAILED DESCRIPTION OF THE INVENTION

This invention provides a secure way of voting at polling locations or online from a phone, tablet, computer or any other device capable of getting online.

This method requires that every voter must register in person to be eligible to vote or by notarized registration forms.

### THE VOTER REGISTRATION PROCESS

1. Voter registration must be conducted by a government representative, authorized agent or notary present to verify voter identification and ensure the voter registration process is conducted properly with all the required identification information.
2. All voters at a registration office must sign a “Voter Sign-in Book” similar to a Notary's book and any and all variations of this. All registered voter's signatures will appear in this sign-in book in sequential order just like the notaries signature book. This process ensures that all voter registration amounts and times coincide with the Voter Registration sign-in book.
3. The voter fills out a voter registration form on a computer keyboard at the voter registration office or the Registration Clerk will type the information on the form for the voter, whichever process is easier for the Voter Registration Organization.
4. Once the form is filled out, the registration clerk verifies and scans the voters ID, has the voter sign an electronic signature pad and place their right index finger on a biometric fingerprint reader (and any and all variations of biometric verification such as facial or iris recognition). An electronic copy of the Voter's I.D., signature and fingerprint are then recorded on the Voter's Electronic Registration Record. This system also has the option to use facial recognition or iris scan in place of the fingerprint or any other secure method of recognition.
5. If the voter chooses to vote online, the voter must set up a username and password while registering in the same method as setting up any online bank account.
6. The voter must sign under penalty of perjury that the voter is eligible to vote and the information is correct to the best of the voter's knowledge.
7. A time, date, location stamp and sequentially generated voter registration serial number or barcode or QR code is created and placed on the voter registration form record at the time the registration form is submitted.
8. The registration computer software system will only allow a voter to register and vote once and ensures this by biometric fingerprint and electronic signature verification. This system also has the option to use facial recognition or iris scan in place of the fingerprint.
9. The Voter Registration number is created as such: Abbreviation for “Voter Registration #” (VR), the State (NV), County (CC), registration office number (99) and a sequentially generated number (104) given to each registered voter through that particular registration office. An Example of the 104th person to register in Registration Office 99 in Clark County, Nev. would read as such: VR #-NV-CC-RO-99-104. Or any other variations as situation arise.
10. When the above is completed, the voter is legally registered to vote. The Registration Clerk prints off hard copies of the registration form on proprietary watermarked paper or counterfeit proof paper (or equivalent) for the voter and the Registrar of Voters records.
11. There are 3 separate copies of records of the Voter's registration which are: The Registrar's hard copy, the voter's hard copy and the Registrar's digital copy. The digital copy is the copy that coordinates with the ballot printing machine to verify the voters' identity and eligibility to vote. The voter's registration form has the following information but each jurisdiction may add other requirements:
   Name
   Address
   Date of birth.
   Place of birth.
   Signature under oath of eligibility to vote.
   Naturalization number if applicable.
   Phone number (optional)
   Scan of photo ID
   Electronic keypad signature.
   Biometric fingerprint or optional facial recognition or iris scan.
   Name change information if applicable.
   Voter registration number created in consecutive and alphabetical order.
   Time, date and location of registration.
   Optional: email, username and password for voting online.
   The username and password are only known by the voter.
12. All original and receipt copies are printed on proprietary watermarked or counterfeit-proof paper for authentication and preventing counterfeiting.

### VOTING ONLINE PROCESS

a. From a computer, tablet or phone, the Voter uses the voter registration number and the username and password created during the voter registration process, to pull up a blank ballot on the computer screen.
b. This blank ballot is unique to the particular voter by way of the Voter's Registration Number, barcode or QR Code created during the Voter Registration process appearing at the bottom right hand side of the ballot or any variation or method thereof.
c. When the voter has completed the ballot on the computer's touch screen, the voter is ready to submit the ballot online.
d. A refundable donation of $1.00 to the Registrar of Voters (or chosen entity) will be required to cast the completed ballot online. This donation adds a very important layer of verification to ensure the integrity of the online voting process and preventing fraud.
e. The $1.00 donation makes it extremely difficult for bad actors to create mass online voter fraud as they would have to create a separate financial paper trail for each fraudulent ballot they attempt to submit online.
f. Every ballot submitted online will have a Ballot Serial Number created in sequential order at the time the ballot is submitted (cast) online of the particular county the Voter is registered in. Each ballot will also have a time and date stamp with the exact time and date the ballot was submitted online. An example of a ballot number for the 3040th ballot submitted online that was registered in Clark County, Nev., the Ballot Number would appear as such: NV-CC-ONLINE-B3040. This Ballot Number will be the same number used on the Election Results Website to record the ballot results.
g. Upon online Submission of the ballot, the voter can print off or save an exact copy of the ballot submitted with all of the above information.
h. Every online ballot submitted is printed off in hard copy in one central location managed by the State. This location prints and stores all online ballots in the order they are received. The storehouse facility for these ballots is under constant video security and are under lock and key.
i. Every online voter will be sent a confirmation email to the email address the voter gave on their Voter Registration Record, that denotes that they voted and the method of payment for donating $1.00 to vote online, thereby adding another layer of verification and security to the online voting process, similar to any financial online banking transaction.
j. The online Voter's username, password and $1.00 donation takes the place of the electronic signature and biometric fingerprint when voting in person as described below.

### IN-PERSON VOTER BALLOT ACQUISITION (PRINTING)

### At the Polling Location:

a. The in-person voting process is done by easy to use on-demand paper ballot printing machine and a ballot reader-tabulating machine.
b. The Ballot Printing Machine is the on-demand ballot printer. The voter types in their name, signs the electronic signature pad and places their right index finger on the biometric fingerprint reader on the Ballot Printer Machine. This machine can also be set up for facial or iris recognition in place of signature verification. The Ballot Printer Machine has secure access to the State's Voter Registration Records. The machine also may have to option of facial recognition or iris scan if set up as such at the voter registration.
c. If the voter's name, signature and fingerprint (or facial recognition) is validated with the information from the Voter's Registration Record, the Ballot Printer Machine will print out the voter's ballot on proprietary watermarked or counterfeit-proof paper or equivalent. The Voter's printed paper ballot will have the Voter's Registration number and barcode (or QR code) printed on the bottom right hand corner of the ballot. This is printed proof on the ballot that the Voter is registered and authorized to receive a ballot and vote.
d. The barcode is a summary of the registered voters' information and tells the Ballot Submission Machine that the ballot is authentic and eligible to be counted.
e. It is to be noted that each ballot is unique to each voter by way of the Voter's Registration number and barcode (or QR code) printed on the bottom right hand corner (and any and all variations of this).

### BALLOT COUNTING AND RECORDING RESULTS

a. When the voter completes filling in the ovals (and any and all variations of this) on the paper ballot, the Voter will cast the ballot by feeding the completed ballot into the document feeder slot on the Ballot Reader-Submission Machine (tabulator). The Reader-Ballot Submission Machine will read the barcode and determine if the ballot is authentic and eligible to be counted. An image of the ballot will appear on a monitor screen with superimposed electronic images of red circles (and/or any and all variations of this) around every ballot oval dot filled in by the Voter. This red circle process verifies to the Voter that the ballot counter in the Ballot Submission Machine (tabulator) has read the paper ballot results correctly.
b. The voter looks over the ballot on the monitor screen to verify that images of red circles are around all ballot oval dots that are filled in (and any and all variations of this). When the voter determines the tabulator has read and placed images of red circle marks on the ballot correctly, the voter will press the “submit and print” button (and any and all variations of this) where the tabulator will print the same red circles (or marks) onto the Voter's original ballot and gives the ballot a sequentially generated Ballot Serial Number and generates a time and date stamp including the Ballot Submission Machine ID number (and any and all variations of this).
c. An exact copy of the original ballot with the red circle marks, Ballot Serial Number, time and date stamp, and machine ID number is then printed off for the Voter on proprietary watermarked paper or equivalent (and any and all variations of this). This exact ballot copy becomes the Voters “Voting Receipt” that the voter will use to verify the results were recorded correctly on the Online Ballot Results Website's Ledger Sheet. At this point the ballot results become part of the official poll election results stored inside the memory of the Ballot Reader-Submission Machine.
d. The original paper ballot will be stored in a locked box in the machine, (and any and all variations of this).
e. The Ballot Submission Machine stores all the ballot images and results of all the ballots submitted through the machine. This information will be stored in the Ballot Submission Machines memory for the life of the machine. The results are not meant to be deleted from the machine. This gives another layer of verification if needed.
f. It is to be noted that all ballot numbers are shuffled in lots of 10 (or any other chosen number) to prevent a person in line from knowing what the next persons ballot number is. In other words, nobody in line will be able to guess any other person's ballot number as the consecutively generated ballot numbers are shuffled in lots of 10, (and any and all variations of this). Guessing a ballot number is like guessing 1 out of 10 (or any shuffle number chosen).

### END OF ELECTION PROCEDURES

g. At the end of the election the images of all ballots, ballot summary and ballot results ledger sheet are uploaded from each Ballot Submission Machine onto a flash-drive or equivalent to be transferred to the States Mainframe Computer and at least one other official location. The ballot results are organized onto a Ledger Sheet (and any and all variations of this) in numerical and alphabetical order of ballot serial numbers (and any and all variations of this), showing the results of each ballot. The information on the flash drive is sent by another computer as the Ballot Submission Machine does not have a modem and is not designed to be able to connect to the internet. The Machines USB port can only upload the voting information (and any and all variations of this) to a flash drive or equivalent.
h. The Ballot Submission machine is designed to not be able to download any information or programs into the Ballot Reader-Submission Machine. This ensures that there is no way to tamper with the Ballot Submission Machine online or from remote sources.
i. When the Voter's original paper ballot is cast, the Ballot Submission Machine automatically places the original paper ballot in the machine's “original ballot box” inside a locked compartment inside the Ballot Submission Machine. When the box inside the compartment is full or the election has ended, the box is removed, labeled and an official seal is placed on the box to prevent any type of ballot tampering. There is a slot in the top of the box where the signed poll certification, poll summary and flash drive can be dropped through this slot into the box and stored with the original ballots, and any and all variations of this.
j. When the election has ended, the Ballot Submission Machine's Ledger Sheet, election results summary and pole certification document is printed out in hard copy. The electronic information on the Ballot Submission Machine is uploaded to a flash drive to be sent to the States Mainframe Voting Results Website Computer and other locations (and any and all variations of this). All hard copies and flash drives are placed inside the original ballot box along with the Poll Certification (and any and all variations of this).
k. A summary of totals of all the pertinent voting information on the Ballot Reader-Submission Machine's Ledger Sheet is compiled on the Poll Certification Sheet which will be verified and signed off by two responsible poll workers under oath, and any and all variations of this.
l. The total number of ballots on the Ledger Sheet shall match the total number of paper ballots and the ballot totals on the Poll Certification Sheet. The Ballot Reader-Submission machine counts the amount of original paper ballots that are placed in the Original Box. This paper ledger and Poll Certification Sheet will then be scanned, copied and placed in the Precinct Records and sent to the State's mainframe computer and at least one other State location. The scanned copies of the Poll Certifications can be viewed by the public online on the States Election Results website.
m. This same electronic Ballot reader-Submission Machine Ledger Sheet will appear on the “State's Official” Election Results website. This Ledger Sheet compiles all the totals that were run through the machine. The public can view the electronic image of any ballot. Only the Voter's registration number and time and date stamp is blotted out to protect voter identity, and any and all variations of this. Only official personnel can see a ballot with the Voter Registration number, time and date stamp and all official personnel are under legal requirement to not divulge any Voter Registration information.
n. This verification process insures that any type of voter fraud will be detected immediately, just as with in any credible accounting system. This voting system is virtually impossible to fraud without detection. Just like bank accounts.
o. The original flash drive of each Ballot Submission Machine results is stored with all the original paper ballots, Ballot Ledger Sheet and Poll Certification inside the sealed ballot box. The complete information on the flash-drive is sent electronically to several different official locations for security and verification reasons and exactly matches all hard copies that are scanned and sent to the same location.
g. At the end of the election, the results of each poll Ballot Reader-Submission Machine will be sent to the State's Mainframe Computer where the results of the election are officially logged into the State's Election Results Website and displayed on the ONLINE ELECTION RESULTS LEDGER SHEET to the public. This Ledger Sheet shows all ballot numbers in consecutive and alphabetic order with their corresponding ballot results, and any and all variations of this.
   Any person can go online to the ONLINE ELECTION RESULTS WEBSITE LEDGER SHEET where all the ballot numbers are listed in alphabetical and sequential order with the results of each ballot count. This ensures that every voter can verify their ballot (or any receipt copy) was counted correctly with complete anonymity.
h. The public can audit an election from any devise that can operate online with the information provided on the Official Election Results Website, comprising of:
   a. The Election Results Ledger Sheet.
   b. Links to electronic images of all ballots (with blotted out registration numbers, time and date stamp).
   c. Poll Certifications that detail total vote tallied and total ballots submitted at any particular polling location.
i. Official recounts can be performed by running original ballots through a tabulator and/or hand counting and matching the results to the Poll Certifications and the Elections Result Ledger Sheet.
j. Any ballot can be viewed online with all the information except for the Voter's Registration number and time and date stamp that is blotted out to the public.
   This method of sequential ballot serial numbers will prevent fraudulent votes from being introduced into the system undetected as the total number of voters and results are certified by every precinct with time, date and machine number stamps on every ballot.
NOTE: All precinct totals are certified at the poll with proof of such by signed hard copy that are scanned to be sent to other official locations.

### ALL ONLINE AND POLL BALLOT NUMBERS ARE CREATED IN SEQUENTIAL ORDER AND LOGGED AS FOLLOWS

Every poll paper ballot will have a unique serial number that will be generated in sequential order from the particular Ballot Submission Machine at a poll.

### THE PAPER POLL BALLOT SERIAL NUMBERS WILL APPEAR AS SUCH

Starting with the State abbreviation, County abbreviation, poll number, Ballot Submission Machine number and ballot number.
For example: The last ballot serial number of poll number 65, Ballot Submission machine #1 in Clark County, Nev. that had 3,562 voters would read like this:
NV-CC-P65-M1-B3562, and any and all variations of this.

### ONLINE BALLOT SERIAL NUMBERS WILL BE CREATED AS SUCH

The State abbreviation, the County abbreviation (of the county the voter is registered in).
For example: The ballot number of the first online vote would look like this: NV-CC-ONLINE-B1. All online voting results ledgers will appear at the very beginning of the State's ONLINE ELECTION RESULTS LEDGER ahead of the paper ballot ledgers, and any and all variations of this.

Every online ballot serial number is created in sequential order and has a time and date stamp created at the time the ballot is submitted online (cast).

Every submitted ballot will appear on the ONLINE ELECTION RESULTS LEDGER SHEET and will be organized in alphabetical and numerical order, and any and all variations of this.

### VOTER BALLOT VERIFICATION PROCESS

After the polls have closed, all electronic results and data are sent to the States Mainframe Computer and Online Election Results Ledger Sheet. The public will be able to access the Online Election Results Ledger Sheet to verify any ballot results. The public can view the image of any ballot. Only the Voter Registration number and time and date stamp is blotted out to public view. The Voter's original paper ballot copy receipt is used as proof to verify the Online Ledger Sheet results are correct. All indications of fraud will be noticed immediately.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A voting system that allows voters to vote online from the voter's personal computer, smart phone or tablet devices, or vote on paper ballots at the polling location, whereas every said voting method gives a copy of the cast ballot to the voter as a voting receipt with a sequentially generated ballot number, with time and date stamp and voter registration number, or barcode, or QR code, printed on the original and receipt copy, thereby insuring automatic chain of custody of every voting transaction.

2. Voter Registration software that records voter registration information, voter identification, voter's username & password, voter's electronic signature and electronic fingerprint, or facial recognition, or iris scan recognition, that verifies said voter's biometric information that causes the voter's “on-demand” paper ballot to print at the polling locations or ability for the voter to securely vote online.

3. The Registration software in 2 has the ability to communicate with government birth certificate records and naturalization records for verification of eligibility to vote and won't allow a person to register or vote more than once.

4. Online voting software that allows a voter to connect with the online voting website using a username and password created during voter registration to pull up an online ballot to be filled out electronically and submitted (cast) online, with the ability for the voter to save and print a copy of the completed and cast ballot.

5. The online voter will pay a $1.00 refundable donation with the voter's method of online payment, causing financial paper trail in which a PDF copy of the cast ballot and payment method emailed to the voters email that is on file in the voter's registration records.

6. A polling station “On-Demand” paper ballot printer that communicates with the voter registration records and verifies the voter's electronic signature, electronic fingerprint or facial recognition or iris scan, using an electronic signature pad and electronic fingerprint reader or facial or iris recognition hardware, to print out a paper ballot proprietary paper with the voter's unique voter registration number, or barcode or QR code printed on the ballot, with a time and date stamp.

7. A ballot reader-tabulator machine to be used at the polling station that reads the completed original paper ballot, brings up an image of the completed ballot on the monitor screen, superimpose colored circle verification marks (or equivalent) on all filled in oval bubbles, prints the verification marks on the original ballot, generates and prints on the original ballot a ballot number, time & date stamp, tabulator number stamp, stores the electronic results, stores the original paper ballot and prints a copy of the stored original ballot for the voter.

8. The above reader-tabulator in 7, does not have a modem, cannot be connected to the internet, cannot download information from any external source and has only one accessible USB port that can only upload election results information to a separate storage device (such as a flash drive) that is used to transfer the information online or physically to the State's election mainframe computer and other required locations.

9. Election Results Software that allows the Election Officials to create an Election Results Website that shows all ballot results in a ledger spread sheet by alphabetical and numerical order, with links to images of all ballots, poll certification sheets and poll results summary sheets, that the public can access the information online for complete transparency and audit capability.

10. All machines and software in this voting system may include one or more languages and the voter can access the language of choice.

11. All ballots whether electronic or paper will have an option for write-in votes.
